(19) United States
(12) Patent Application Publication
(10) Pub. No.: US 2007/0234483 A1
(43) Pub. Date: Oct. 11, 2007

(54) EXTENDABLE UTILITY DEVICE AND ASSOCIATED METHOD

(76) Inventors: Justin Kunz, South Burlington, VT (US); Charles E. Root JR., Milton, VT (US); Ryan K. Simmons, Waterbury, VT (US)

Correspondence Address: Ryan Simmons, 19 Union St#2, Waterbury, VT, 05676, US

(21) Appl. No.: 11/278,950

(22) Filed: Apr. 6, 2006

(51) Int. Cl. B25D 1/04; B25F 1/00

(52) U.S. Cl. 7/143; 33/342; 7/146; 7/150

(57) ABSTRACT

The invention provides an extendable utility device including: a central housing; one or more extendable members attached to the central housing; one or more spirit vials (i.e., a level) embedded in the central housing; and one or more wall markers attached to the extendable members. The extendable members extend from and retract into the central housing, and the wall markers are individually positioned perpendicular to, and at the ends of each of the extendable members.

### 1. FIELD OF THE INVENTION

The field of the invention pertains to household tools. In particular, the invention pertains to a convenient household tool that integrates many of the functions required for hanging or mounting items to a wall to ensure they are level.

### 2. BACKGROUND OF THE INVENTION

One of the more common household tasks involves the hanging or affixing of a picture, frame, shelf, ledge, or other object to a wall or other surface. Given the recent trend in which more individuals are becoming interested in home decorating, designing, and “do it yourself” projects, what would be traditionally left up to a handyman to do is now gaining interest with laypersons e.g., the “do-it-yourselfers.”

Traditionally, one first determines the placement (i.e., height and/or width) of an object to be mounted on a surface, such as wall. This is usually done with a measuring tape and may involve measuring more than one location for a fastener such as a screw and/or anchor that will secure the object. Additionally, it may be also necessary to verify the object will be level with either the ceiling, floor, or other objects on a wall, and/or that the object will be perpendicular with either a corner or edge of the wall or other objects on the wall. Next, a user typically makes a mark in the desired location(s) using a pen, pencil, or by creating a small starter hole(s). This starter hole may require the use of a sharp object and rigid head such as a hammer or other object for striking the sharp object.

Therefore, it is the typical case that in order to hang or affix a object to a wall with relative precision and levelness, it is required to have a measuring tape, a level, means for marking such as pen or pencil, and perhaps a hammer. While these are common tools that are owned by nearly every handyman, it is less likely that the everyday layperson would own each of these tools, and even if they do own all such tools it is often cumbersome to use these tools, especially if attempting to mount the object by oneself. What is needed is a single utility tool that integrates and provides many of the functions required for hanging or mounting objects to a wall, which includes measuring, leveling, and marking.

In addition to the common problem of needing three or four different tools to accomplish a single job of hanging or affixing a object, the market is driving the need in the tool industry for smaller, all in one, and less expensive tools. Consumers are interested in having the ability to buy a small tool at a checkout counter, or even have this tool available as part of the object, as evidenced by the “Level-Line” series of wall décor products that incorporates a built-in leveling system and is being included in many of the Burnes of Boston wall fixture product offerings.

Additionally, in the case that a fixture is mounted using one or more nails, what is also needed is a single utility tool that integrates and provides functions required for hanging or mounting items to a wall which includes measuring, leveling, marking, and securing a fastening device, such as a nail or screw to a surface, and being able to locate a wall stud for added security in mounting heavier objects.

Further objects and advantages of this invention will become apparent from the figures and related description.

### 3. SUMMARY OF THE INVENTION

The invention provides an extendable utility device including: a central housing; one or more extendable members attached to the central housing; one or more spirit vials to determine levelness embedded in the central housing; and one or more wall markers attached to the extendable members. The spirit vials may be positioned at one or more angles, for example 45, 90, and 180 degrees. The extendable members extend from and retract into the central housing, and the wall markers are individually positioned perpendicular to, and at the ends of each of the extendable members.

The extendable utility device further includes a series of measurement markings that run the length of the central housing and extendable members. Additionally, a pocket clip is attached to the central housing to accommodate convenient storage and transport in a shirt pocket, for example. Alternatively the extendable utility devices may further include a stud finder incorporated into the central housing, as well as a hammer head fixedly attached to one end of the central housing.

A method of using the extendable utility device includes: placing the extendable utility device against a surface; extending the extendable members to a desired length; adjusting the extendable utility device along the desired plane to establish levelness; and then marking surface with the wall markers. If necessary a user may first locate a wall stud using the stud finder incorporated into the extendable utility device. Additionally, a user may secure a fastener to the surface using a hammer head fixedly attached to one end of the extendable utility device.

### 4. BRIEF DESCRIPTION OF THE DRAWINGS

FIG. 1A illustrates an extended extendable utility device

FIG. 1B illustrates a second embodiment of an extended extendable utility device.

FIG. 1C illustrates a collapsed extendable utility device.

FIG. 2A illustrates a front view of a third embodiment of an extended extendable utility device.

FIG. 2B illustrates a rear view of a third embodiment of an extended extendable utility device.

FIG. 2C illustrates a cross sectional view of a third embodiment of an extendable utility device.

FIG. 3 illustrates a fourth embodiment of an extended extendable utility device.

FIG. 4 illustrates a front view of a fifth embodiment of an extended extendable utility device.

FIG. 5 illustrates a sixth embodiment of an extended extendable utility device.

### 5. DETAILED DESCRIPTION OF THE INVENTION

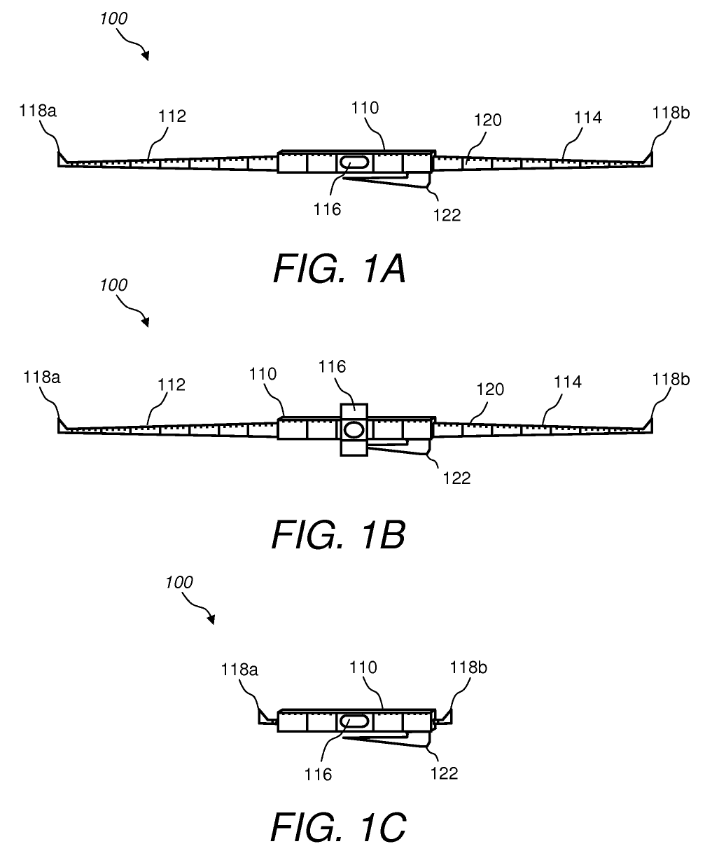

FIG. 1A illustrates an extendable utility device 100 in accordance with the invention. Extendable utility device 100 provides measuring, leveling, and marking functions in a single, convenient, easy-to-use tool that would otherwise be accomplished with multiple tools based on current products available today.

Extendable utility device 100 includes a central housing 110, a first extendable member 112, and a second extendable member 114. Central housing 110 includes a spirit vial 116. First extendable member 112 and second extendable member 114 further include wall markers 118a and 118b respectively. Wall markers 118a and 118b are positioned perpendicular to, and are at the distal ends of first extendable member 112 and second extendable member 114 respectively. First extendable member 112, second extendable member 114, and central housing 110 further include a series of measurement markings 120 along the length of each first extendable member 112, second extendable member 114, and central housing 110. Central housing 110 further includes a pocket clip 122.

Central housing 110, first extendable member 112 and second extendable member 114 are composed of plastic, metal, fiberglass, or other suitable material. First extendable member 112 and second extendable member 114 are preferably extendably attached to central housing 110, one at each end of central housing 110 in a coplanar orientation, such that first extendable member 112 and second extendable member 114 individually are capable of being extended outward from said central housing in opposite directions. First extendable member 112 and second extendable member 114 may be attached to central housing 110 using adhesive, welding, clamping, molding, or any suitable attachment mechanism, which would be obvious to one of ordinary skill in the art. First extendable member 112 and second extendable member 114 may each contain a plurality of sub-pieces that retract or extend in a conventional, telescopic manner, which is well known in the art. Note that, as is the case with other conventional telescopic devices, each sub-piece becomes progressively smaller in diameter as first extendable member 112 and second extendable member 114 is each extended from central housing 110. While seven different sub-pieces are illustrated in FIGS. 1A and 1B for purposes of the invention, it should be understood that extendable utility device 100 may contain any number of sub-pieces depending on desired maximum extended length of extendable utility device 100.

Measurement markings 120 along the length of first extendable member 112, second extendable member 114, and central housing 110 provide a consistent, visible representation of the extended length. Measurement markings 120 may be printed, etched, or engraved onto first extendable member 112, second extendable member 114, and central housing 110. It should be understood that any measurement marking consistent with the size of each sub-piece may be utilized in the invention, and may in fact vary depending on the geographic region or particular use of extendable utility device 100. For example, measurement markings 120 may be in metric or English units. Preferably, measurement markings 120 are consistent across first extendable member 112, second extendable member 114, and central housing 110.

As first extendable member 112 and second extendable member 114 are extended and retracted, wall markers 118a and 118b remain exposed. In a preferred embodiment of the invention, wall markers 118a and 118b are made of metal, plastic, fiberglass or other suitable marking material, and are perpendicular to first extendable member 112 and second extendable member 114, respectively. The points of wall markers 118a and 118b are of the same height relative to each other so as to provide for level marking at whatever length either first extendable member 112 and/or second extendable member 114 is extended. Wall markers 118a and 118b may be of vary heights, including but not limited to 1/16, ⅛, or ¼ inch. Wall markers 118a and 118b may be formed on first extendable member 112 and second extendable member 114 using molding or other suitable mechanisms. Alternatively wall markers 118a and 118b may be fixedly attached using welding, soldering, or other suitable mechanism to first extendable member 112 and second extendable member 114. In yet another example, wall markers 118a and 118b may be removably attached using any suitable mechanism to first extendable member 112 and second extendable member 114. In other embodiments of the present invention, wall markers 118a and 118b are interchangeable pieces of pencil lead, marker tips, or pen ink. Caps or other protective mechanisms may also be included to protect wall markers 118a and 118b when not in use.

Spirit vial 116 is any conventional spirit vial used for the purpose of establishing a level plane, and is housed within central housing 110 using any number of conventional attachment mechanisms, including but not limited to spring clips, pressure clips, form fitting, “C” clips, etc. Alternatively, spirit vial 116 may be permanently housed in a recess within central housing 110 by molding or other mechanism, which would be obvious to one of skill in the art. Spirit vial 116 provides conventional leveling functionality as extendable utility device 100 is used.

With reference to FIG. 1B a further embodiment of the invention pertains to the ability to attach items on a surface plumb. In order to do this the device must be placed against the surface vertically and spirit vial 116 must be rotated so that it is perpendicular to central housing 110.

In one example, to facilitate this rotation and then positioning in a perpendicular fashion, the outer casing of central housing 110 has two “C” shaped notches (not shown) opposite one another above and below spirit vial 116. Spirit vial 116 is removable from its position in central housing 110 where it can then be secured in to the two “C” shaped notches and held in place by using any conventional attachment mechanisms, including but not limited to spring clips, pressure clips, form fittings, C clips, or other mechanism, which would be obvious to one of skill in the art. Spirit vial 116 will now be perpendicular to extendable utility device 100, thus allowing a user to make level plumb lines.

Pocket clip 122 is any conventional pocket clip made of plastic, metal, fiberglass, or other suitable material, which is known in the art. While pocket clip 122 is illustrated in FIGS. 1A, 1B, and 1C as being attached to central housing 110, it should be understood that the placement of pocket clip 122 may be attached anywhere along the extendable utility device 100, but so as not to interfere with extendibility and measurement of the tool.

The generalized operation of extendable utility device 100 is as follows. Extendable utility device 100 may be placed against a surface, such as a wall, on which to mount an object. A user of extendable utility device 100 extends first extendable member 112 and/or second extendable member 114 using measurement markings 120 to achieve the desired length. Next, the user adjusts the horizontal or vertical positioning of extended extendable utility device 100 until spirit vial 116 is centered, thus assuring a level or plumb measurement. Finally, the user rotates extendable utility device 100 inward towards the mounting surface so that wall markers 118a and 118b make two visible marks, which together provide a level or plumb plane and desired measurement. Extendable utility device 100 can easily be retracted to a smaller size (as shown in FIG. 1C) and placed conveniently in a pocket utilizing pocket clip 122.

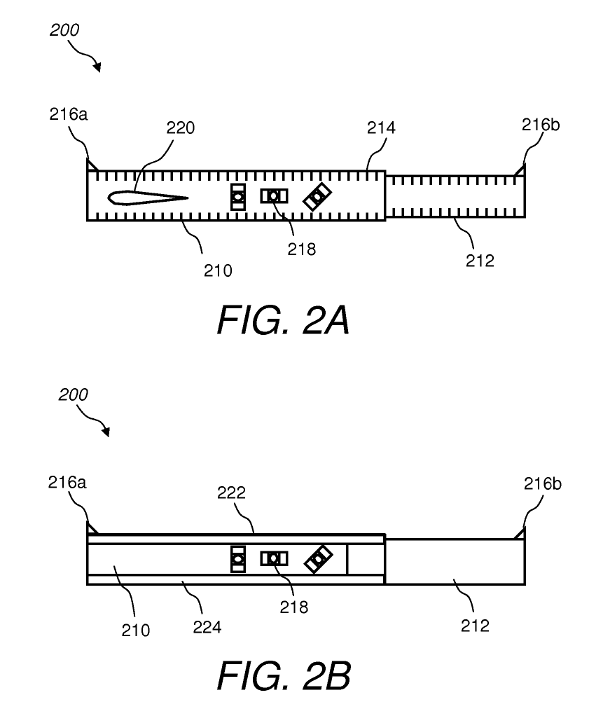

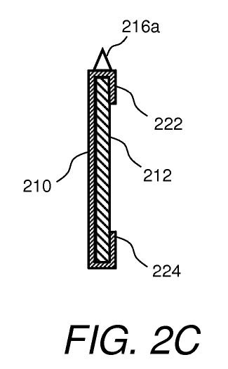

FIGS. 2A and B illustrates an alternative extendable utility device 200 in accordance with the invention. Extendable utility device 200 provides complete measuring, leveling, and marking functions in a single, convenient, easy-to-use tool that would otherwise be accomplished with multiple tools based on current art and products available in the market today.

Extendable utility device 200 includes: a central housing 210 and an extendable member 212. Central housing 210 further includes a series of measurement markings 214; wall markers 216a; one or more spirit vials 218; a conventional pocket clip 220; a top rail 222; and a bottom rail 224. Extendable member 212 further includes measurement markings 214 and a wall marker 216b.

Central housing 210 and extendable member 212 are composed of plastic, metal, fiberglass, or other suitable material and function as conventional sliding pieces. That is, extendable member 212 slides outward from central housing 210 to increase the total length of extendable utility device 200, and slides inward towards central housing 210 to shorten extendable utility device 200 to make more convenient for storage. Extendable member 212 slides outward and inward using top rail 222 and bottom rail 224 as guides and as support as extendable member 212 is extended or retracted.

FIG. 2C illustrates the structural relationship of central housing 210 and extendable member 212 where top rail 222 and bottom rail 224 act as supports and guides to facilitate the extension and retraction of extendable member 212.

Measurement markings 214 running along the length of central housing 210 and extendable member 212 provide a consistent, visible representation of the extended length. It should be understood that any measurement marking consistent with the size of central housing 210 and extendable member 212 may be utilized in the invention, and may in fact vary depending on the geographic region or particular use of extendable utility device. For example, measurement markings 214 may be in metric or English units. Preferably, measurement markings 214 are consistent across central housing 210 and extendable member 212. Measurement markings 214 may be printed, engraved, or etched onto extendable member 212 and central housing 210.

As extendable member 212 is extended and retracted, wall markers 216a and 216b remain exposed. In a preferred embodiment of the invention, wall markers 216a and 216b are made of metal, plastic, fiberglass, or other suitable marking material, and are perpendicular to central housing 210 and extendable member 212, respectively. The points of wall markers 216a and 216b are of the same height relative to each other so as to provide for level marking at whatever length extendable member 212 is extended. Wall markers 216a and 216b may be of vary heights, including but not limited to 1/16, ⅛, or ¼ inch. Wall markers 216a and 216b may be formed on first extendable member 112 and second extendable member 114 using molding or other suitable mechanisms. Alternatively wall markers 118a and 118b fixedly attached using welding, soldering, or other suitable mechanism to first extendable member 112 and second extendable member 114. In yet another example, wall markers 118a and 118b may be removably attached using any suitable mechanism to first extendable member 112 and second extendable member 114. In other embodiments of the present invention, wall markers 216a and 216b are interchangeable pieces of pencil lead, marker tips, or pen ink. Caps or other protective mechanisms may also be included to protect wall markers 216a and 216b when not in use.

One or more spirit vials 218 are any conventional spirit vials used for the purpose of establishing a level plane, and is housed within a recess in central housing 210, using any number of conventional attachment mechanisms, including but not limited to spring clips, pressure clips, form fitting, “C” clips, etc. Alternatively, one or more spirit vials 218 may be permanently housed in a recess within central housing 210 by molding or other mechanism, which would be obvious to one of skill in the art. One or more spirit vials 218 provide conventional leveling functionality as extendable utility device 200 is used. Three variations of levels (90, 180, and 45 degrees) are illustrated with respect to FIGS. 2A and 2B. However, it is understood that the invention provides for any type of level measurement for use with extendable utility device 200.

Pocket clip 220 is any conventional pocket clip made of plastic, metal, fiberglass, or other suitable material, which is known in the art. While pocket clip 220 is illustrated in FIG. 2A as being attached to central housing 210, it should be understood that the placement of pocket clip 220 may be attached anywhere along the extendable utility device 200, but so as not to interfere with extendibility and measurement of the tool.

The generalized operation of extendable utility device 200 is as follows. Extendable utility device 200 may be placed against a surface, such as a wall, on which to mount an object. A user of extendable utility device 200 extends extendable member 212 relative to central housing 210 using measurement markings 214 to achieve the desired length. Next, the user adjusts the horizontal or vertical positioning of extended extendable utility device 200 until spirit vial 218 of the desired plane (e.g., 45, 90, or 180 degrees) is centered, thus assuring a level or plumb measurement. Finally, the user rotates extendable utility device 200 inward towards the mounting surface so that wall markers 216a and 216b make two visible marks, which together provide a level or plumb plane and desired measurement. Extendable utility device 200 can easily be retracted to a smaller size (and placed conveniently in a pocket utilizing pocket clip 212.

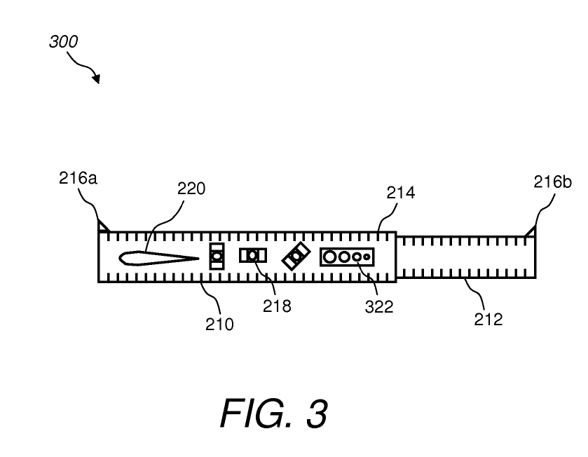

FIG. 3 illustrates an alternative extendable utility device 300 in accordance with the invention. Extendable utility device 300 provides complete measuring, leveling, stud-finding, and marking, functions in a single, convenient, easy-to-use tool that would otherwise be accomplished with multiple tools based on current art and products available in the market today.

Extendable utility device 300 includes: a central housing 210 and an extendable member 212. Central housing 210 further includes a series of measurement markings 214; wall markers 216a; one or more spirit vials 218; a conventional pocket clip 220; a top rail 222; a bottom rail 224; and a stud finder 322. Extendable member 212 further includes measurement markings 214 and a wall marker 216b.

Stud finder 322 is any conventional magnetically and electrically operated stud finder utilizing capacitance to sense the locations of studs within a wall. With respect to FIG. 3, electronics of stud finder 322 are housed within a recess in extendable utility device 300. Preferably, stud finder 322 is housed within a recess located in central housing 210, and preferably with a shock absorbing shield about it. Such shock absorbing shield may be fabricated of a rubberized composition. Stud finder 322 provides an indication when extendable utility device 300 is positioned over a stud either magnetically or electrically, an appropriate alert is given—such as by an audible beeping, or by a flashing light, or both. In one example, stud finder 322 emits a green light when extendable utility device 300 is over a stud and a red light when it is not.

The generalized operation of extendable utility device 300 is as follows. Extendable utility device 300 may be placed against a surface, such as a wall, on which to mount an object. A user of extendable utility device 300 utilizes stud finder 322 to locate a first stud and make a mark using wall markers 216a or 216b. The user then places wall marker 216a or 216b underneath this mark and extends extendable member 212 to the right of central housing 210 to achieve the desired length of measurement. Desired length is confirmed by viewing measurement markings 214 and adjustments may be made to achieve this length by sliding extendable member 212 either outward or inward from central housing 210. Thus, extendable utility device 300 in an extended state provides a total desired measurement. Next, the user adjusts the positioning of extended extendable utility device 300 until spirit vial 218 of the desired plane (e.g., 45, 90, or 180 degrees) is centered, thus assuring a level or plumb measurement. The user then rotates extendable utility device 300 inward towards the mounting surface so that wall markers 216a and 216b make two visible marks, which together provide a level or plumb plane and desired measurement. It is further understood that additional stud finding may be desired at or near the location of the second measurement. Extendable utility device 300 can easily be retracted to a smaller size and placed conveniently in a pocket utilizing pocket clip 220.

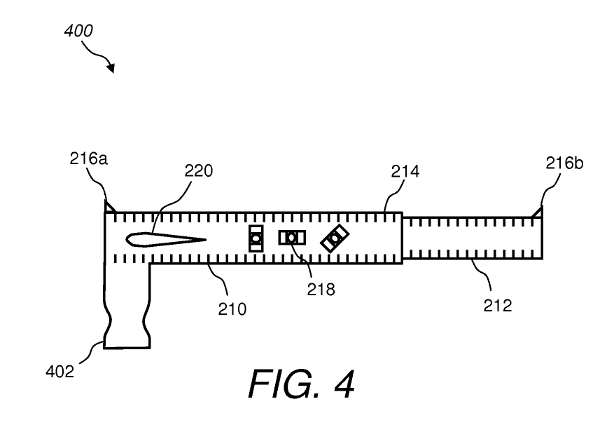

FIG. 4 illustrates another alternative embodiment extendable utility device 400. Extendable utility device 400 includes: a central housing 210 and an extendable member 212. Central housing 210 further includes a series of measurement markings 214; wall markers 216a; one or more spirit vials 218; a conventional pocket clip 220; a top rail 222; a bottom rail 224; and a hammerhead 402. Extendable member 212 further includes measurement markings 214 and a wall marker 216b.

Hammerhead 402 is made of any conventional metal, rubber, or other heavy material that is used for striking and driving. The distal end of central housing 210 is adapted to receive a hammerhead. In FIG. 4, hammerhead 402 is illustrated as being attached to the distal end of central housing 210; however, it should be recognized that hammerhead 402 could alternatively be attached to the distal end of extendable member 212. Hammerhead 402 is preferably light weight preferably 16 ounces or less; however, it should be appreciated that any conventional size hammerhead could be used.

The generalized operation of extendable utility device 400 is as follows. Extendable utility device 400 may be placed against a surface, such as a wall, on which to mount an object. A user of extendable utility device 400 extends extendable member 212 relative to central housing 210 using measurement markings 214 to achieve the desired length. Next, the user adjusts the horizontal or vertical positioning of extended extendable utility device 400 until spirit vial 218 of the desired plane (e.g., 45, 90, or 180 degrees) is centered, thus assuring a level or plumb measurement. Then the user rotates extendable utility device 400 inward towards the mounting surface so that wall markers 216a and 216b make two visible marks, which together provide a level or plumb plane and desired measurement. Finally, hammer head 402 may be used to drive a fastener, such as, a nail at the desired measurement location with which to secure the object to the surface. Extendable utility device 400 can then easily be retracted to a smaller size and placed conveniently in a pocket utilizing pocket clip 212.

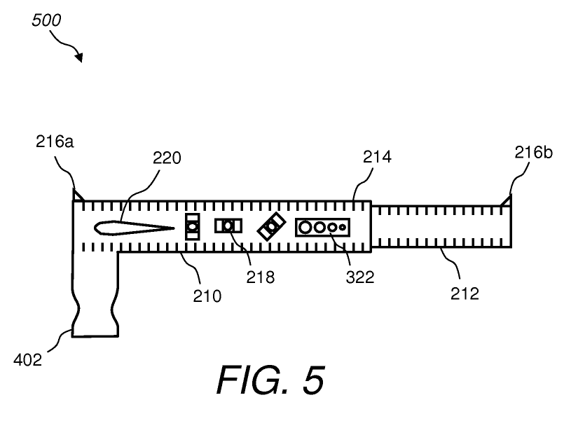

FIG. 5 illustrates another alternative embodiment extendable utility device 500. Extendable utility device 400 includes: a central housing 210 and an extendable member 212. Central housing 210 further includes a series of measurement markings 214; wall markers 216a; one or more spirit vials 218; a conventional pocket clip 220; a top rail 222; a bottom rail 224; a stud finder 322; and a hammerhead 402. Extendable member 212 further includes measurement markings 214 and a wall marker 216b.

The generalized operation of extendable utility device 500 is as follows. Extendable utility device 500 may be placed against a surface, such as a wall, on which to mount an object. A user of extendable utility device 500 utilizes stud finder 322 to locate a first stud and make a mark using wall markers 216a or 216b. The user then places wall marker 216a or 216b underneath this mark and extends extendable member 212 to the right of central housing 210 to achieve the desired length of measurement. Desired length is confirmed by viewing measurement markings 214 and adjustments may be made to achieve this length by sliding extendable member 212 either outward or inward from central housing 210. Thus, extendable utility device 500 in an extended state provides a total desired measurement. Next, the user adjusts the positioning of extended extendable utility device 500 until spirit vial 218 of the desired plane (e.g., 45, 90, or 180 degrees) is centered, thus assuring a level or plumb measurement. The user then rotates extendable utility device 500 inward towards the mounting surface so that wall markers 216a and 216b make two visible marks, which together provide a level or plumb plane and desired measurement. It is further understood that additional stud finding may be desired at or near the location of the second measurement. Finally, hammerhead 402 may be used by the user to drive a fastener, such as, a nail at the desired measurement location into the surface to secure the object to the surface. Extendable utility device 500 can then easily be retracted to a smaller size and placed conveniently in a pocket utilizing pocket clip 212.

### 5.1 CONCLUSION

In addition to the features and advantages of the invention explicitly detailed herein, numerous modifications and changes will readily occur to those of ordinary skill in the art upon review of this disclosure. The invention should be understood to include all such limitations. Accordingly, all suitable modifications and equivalents should be considered as falling within the spirit and scope of the invention.

1. An extendable utility device comprising:
a. a central housing;
b. a plurality of extendable members attached to said central housing;
c. one or more spirit vials housed in said central housing;
d. one or more wall markers attached to said plurality of extendable members; and
wherein, said plurality of extendable members extend from and retract into said central housing, and wherein said one or more wall markers are positioned perpendicular to, and at ends of, said plurality of extendable members.

2. The extendable utility device of claim 1 wherein said central housing and said plurality of extendable members comprise a plurality of measurement markings.

3. The extendable utility device of claim 1 further comprising a pocket clip attached to said extendable utility device.

4. The extendable utility device of claim 1 wherein said one or more spirit vials are positioned at one or more angles.

5. The extendable utility device of claim 4 wherein at least one of said one or more spirit vials is positioned at a 45 degree angle.

6. The extendable utility device of claim 4 wherein at least one of said one or more spirit vials is positioned at a 90 degree angle.

7. The extendable utility device of claim 4 wherein at least one of said one or more spirit vials is positioned at a 180 degree angle.

8. The extendable utility device of claim 1 wherein said central housing further comprises one or more C shaped channels that is perpendicular to said central housing, wherein said one or more C shaped channels can securely hold said one or more spirit vials.

9. The extendable utility device of claim 8 wherein said one or more spirit vials are removably housed in said central housing, whereby said one or more spirit vials can be removed from said central housing and repositioned and housed in said one or more C shaped channels.

10. The extendable utility device of claim 1 further comprising a stud finder housed in said central housing.

11. The extendable utility device of claim 1 further comprising a hammer head attached to a distal end of said central housing.

12. The extendable utility device of claim 1 further comprising:
a. a hammer head fixedly attached to a distal end of said central housing; and
b. a stud finder housed in said central housing.

13. A method of using an extendable utility device comprising:
a. placing said extendable utility device against a surface;
b. extending a plurality of extendable members to a desired length;
c. adjusting said extendable utility device along a desired plane to establish levelness; and
d. marking said surface with one or more wall markers.

14. The method of claim 13 further including the step of:
a. locating a wall stud using a stud finder housed in said extendable utility device prior to any one of steps a-d.

15. The method of claim 13 further including the step of:
a. securing a fastener to said surface using a hammer head attached to one end of said extendable utility device.
